(19) United States
(12) Patent Application Publication
(10) Pub. No.: US 2009/0113353 A1
(43) Pub. Date: Apr. 30, 2009

(54) CURSOR LOCATOR

(76) Inventors: Ravi Prakash Bansal, Tampa, FL (US); Brian Marshall O'Connell, Cary, NC (US); Brian James Snitzer, Lancaster, PA (US); Keith Raymond Walker, Austin, TX (US)

Correspondence Address: IBM CORP (YA);C/O YEE & ASSOCIATES PC, P.O. BOX 802333, DALLAS, TX, 75380, US

(21) Appl. No.: 11/931,562

(22) Filed: Oct. 31, 2007

(51) Int. Cl. G06F 3/048

(52) U.S. Cl. 715/856

(57) ABSTRACT

Illustrative embodiments provide a computer implemented method, data processing system and a computer program product for indicating the location of a cursor within an application to a user. In one illustrative embodiment the computer implemented method comprises initiating a monitoring service to generate collected information regarding the location of the cursor within the application and comparing the collected information with a set of respective predetermined values to create a set of compared values. Responsive to a determination based on the set of compared values, presenting a visual cue indicating the location of the cursor to the user.

### BACKGROUND OF THE INVENTION

1. Field of the Invention

The present invention relates generally to an improved data processing system, and in particular to a computer implemented method, data processing system and a computer program product for indicating a cursor location.

2. Description of the Related Art

A cursor is a movable graphical indicator, pointer or marker that is used to indicate a position within some spatial arrangement. The term cursor has been used for many years with regard to slide rules, typewriters, computers and databases. A cursor is typically a visual indicator used to show the position on a computer display screen, or other display device that will be responsive to a user's input of data. In most command line interfaces, the cursor is typically rendered as one of an underscore, a solid rectangle, or a vertical line character, which may be either flashing or steady, indicating a position on the screen where text will be placed when entered.

Some interfaces also use an underscore character or thin vertical bar character to indicate that the application is in insert mode, in which case, text will be inserted at a position in the middle of the existing text, and a larger block to indicate that the application is in overtype mode, therefore inserted text will overwrite existing text characters.

In text oriented interfaces, including examples such as a console of the Linux™ operating system and many programs written for MS-DOS™, the cursor is frequently a solid rectangle. Depending on the interface implementation, the rectangle may always be a single color, or may be the opposite color of whatever lies on a layer below the cursor to provide strong visual contrast.

Interfaces incorporating use of a computer mouse, or other pointing device, have an additional cursor to show the current position of the computer mouse pointer. Graphical user interfaces usually use an arrow-like pointer to indicate the mouse pointer position, and a solid vertical line to indicate a text insertion point. Some users may reference the insertion point cursor as a caret to distinguish the insertion point cursor variant from the mouse cursor. Other users may describe the two types of cursors as a mouse pointer and a text cursor to make a distinction between the two.

Presently, a user may invoke methods to visually identify the location of a cursor or a mouse pointer. However, the methods used do not automatically invoke routines to display the cursor location based on a user's particular interaction with an application. Manual invocation methods are typically inconvenient for users, or the ability to invoke a method may be unknown to computer use novices. In some cases, applications do not auto-scroll to the cursor location even upon typing data, and sometimes the user wants to be brought back to the cursor location without typing anything into the application. Furthermore, when users attempt to locate the cursor by typing arbitrary text, if the application does not scroll to the text, the user may end up with undesired text inserted into the document and may have to take extra steps to locate the undesired text.

Additionally, current methods do not indicate when a cursor is off-screen, as when left in another portion of a document or placed out of view. Loss of the cursor in such cases typically disorients a user when the user resumes editing a document.

### SUMMARY OF THE INVENTION

Illustrative embodiments provide a computer implemented method, an apparatus and a computer program product for indicating the location of a cursor within an application. In one embodiment, the computer implemented method comprises monitoring the application to generate a set of collected values regarding the location of the cursor, comparing the set of collected values with a set of respective predetermined values to create a set of compared values, and presenting a visual cue indicating the location of the cursor on a display, responsive to a determination based on the set of compared values.

In another embodiment, a data processing system comprises, a bus, a memory connected to the bus, wherein the memory contains computer usable program code, a processor unit connected to the bus and the memory, wherein the processor unit executes the computer usable program code to create a monitor capable of monitoring the application to generate a set of collected values regarding the location of the cursor, create a comparator capable of comparing the set of collected values with a set of respective predetermined values to create a set of compared values, and create a cue function capable of presenting a visual cue indicating the location of the cursor on a display, responsive to a determination based on the set of compared values.

In another embodiment, a computer program product comprising computer usable program code tangibly embodied on a computer usable recordable type medium, the computer usable program code comprising computer usable program code for creating a monitor capable of monitoring the application to generate a set of collected values regarding the location of the cursor, computer usable program code for creating a comparator capable of comparing the set of collected values with a set of respective predetermined values to create a set of compared values, and computer usable program code for creating a cue function capable of presenting a visual cue indicating the location of the cursor on a display, responsive to a determination based on the set of compared values.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2, is a block diagram of a data processing system of FIG. 1 in which illustrative embodiments may be implemented;

FIG. 3 is a block diagram of a typical software architecture for a data processing system in accordance with illustrative embodiments;

FIG. 4 is a tabular view of a typical set of collected data in accordance with illustrative embodiments;

FIG. 5 is a block diagram of major components of the cursor location service, in accordance with illustrative embodiments;

FIG. 6 is an example of a visual cue in an application in focus, in accordance with illustrative embodiments; and

FIG. 7 is an example of a visual cue in an application when a cursor is off screen, in accordance with illustrative embodiments;

FIG. 8 is a flowchart of the cursor location service process in accordance with illustrative embodiments.

### DETAILED DESCRIPTION OF THE PREFERRED EMBODIMENT

The use of “cursor” within the scope of this description applies to use of the text input cursor.

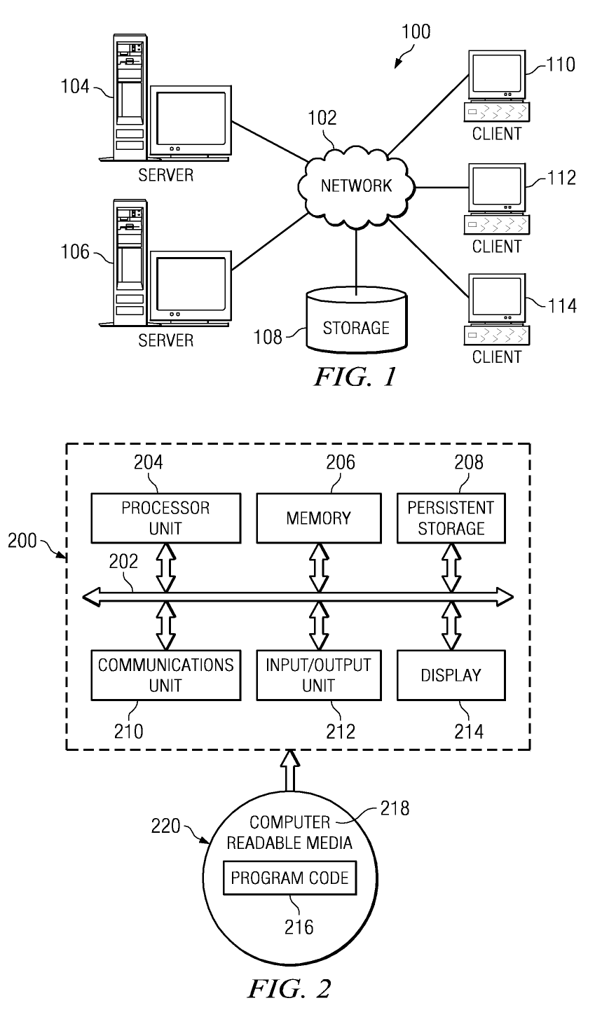

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Clients 110-114 may access applications contained on a server such as server 106 and in doing so use a graphical user interface of the application. The graphical user interface provides a space in which cursor location may be relevant to a user of the application in the performance of application related tasks. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

Illustrative embodiments provide a capability for creating a monitor to monitor an application to generate a set of collected values regarding the location of the cursor within the graphical user interface space of an application and comparing the set of collected values with a set of respective predetermined values to create a set of compared values. Responsive to a determination based on the set of compared values, presenting a visual cue indicating the location of the cursor to the user. The set of respective predetermined values are typically obtained from a corresponding set of predetermined values in a configuration data. The phrase “a set,” as used herein, refers to one or more items. For example, a set of collected values is one or more collected values, and a set of predetermined values is one or more predetermined values.

For example, in a spreadsheet application a user may be scrolling through pages of data, and as a result, the cursor location may be many pages behind the current view on the display. In accordance with embodiments of the present invention the actual location of the cursor would be tracked and compared to a need of the application to be cursor sensitive and to update the user. The user would then receive a visual cue, on the current display, indicating the location of the cursor.

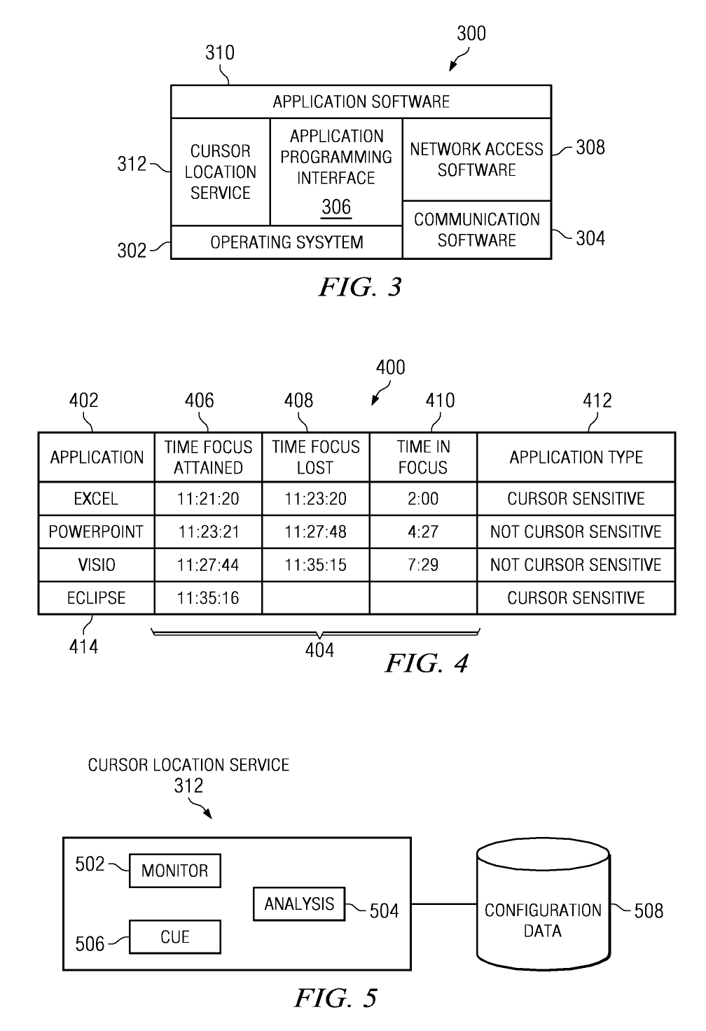

Turning to FIG. 3, typical software architecture for a data processing system is depicted in accordance with an illustrative embodiment. At the lowest level of data processing system 300, operating system 302 is utilized to provide high-level functionality to the user and to other software. Such an operating system typically includes a basic input output system (BIOS). Communication software 304 provides communications through an external port to a network, such as the Internet, via a physical communications link by either directly invoking operating system functionality or indirectly bypassing the operating system to access the hardware for communications over the network.

Application programming interface (API) 306 allows the user of the system, such as an individual or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers. Application software 310 represents any number of software applications designed to react to data through the communications port to provide the desired functionality the user seeks. Applications at this level may include those necessary to handle data, video, graphics, photos, or text, which can be accessed by users of the Internet. The cursor location service 312 may be implemented within application programming interface software 306, typically in a device driver component, in these examples. Cursor location service 312 incorporates interfaces to both the application software 310 and the operating system 302 to obtain access needed for monitoring and display capabilities.

With reference to FIG. 4, a tabular view of a typical set of collected data in accordance with illustrative embodiments is shown. The example table 400 illustrates a set of example applications 402 for which focus timing information 404 has been recorded, as well as an indication of an application type 412. The application type 412, as used in the example, indicates a property of cursor sensitivity.

The focus timing information 404 in the time related columns indicate the start time of when the respective application became the application in focus, time focus attained 406, and the corresponding time at which the application lost focus, time focus lost 408. The remaining time column represents the duration or time between the time focus attained 406 and the time focus lost 408, time in focus 410. Out of focus time may be derived from the difference between the time focus lost 408 and the current time.

The example application in row 414 indicates Eclipse has attained focus, but has not lost focus yet. When an application is exited and closed, the corresponding record for that application is removed from the table 400.

With reference to FIG. 5, a block diagram of major components of the cursor location service in accordance with illustrative embodiments is shown. Cursor location service 312 of FIG. 3 comprises software components covering three functional areas. A monitoring function is provided by monitor 502, an analytical function performed by analysis 504, and a cue providing function by cue 506.

Monitor 502 provides a subsystem comprising capabilities of a location tracker for tracking the location of the cursor within the application. This function may be implemented using, for example, an operating system service, such as Microsoft® .NET framework function call of GetCursorPos ( ) or in another example, an application programming interface function, to provide periodic indications of the position of the cursor and to then store that information in a table or array of collected values for later use.

Monitor 502 also provides a subsystem comprising capabilities for tracking the viewable display. As in the case of tracking the location of the cursor within the application, the function of tracking the viewable display may also be implemented using either an operating system provided function or an application programming interface accessible function. The function of tracking the viewable display receives periodic indication of the window size and the elements of the application viewable within the window.

Monitor 502 additionally provides a subsystem comprising capabilities for tracking the time the application is in focus and the amount of time since each application has been in focus. The data may be obtained through the operating system provided functions to determine which application window is in active focus. The data may typically then be gathered and stored in tabular form as in the example of FIG. 4.

The analytical function provided by analysis 504 comprises a comparator and configuration data 508. Configuration data 508 comprises a set of attributes and corresponding values related to elements subject to comparison as a result of monitoring. Elements may include, but are not limited to, an application type in which an application is defined to be cursor sensitive, and requiring notice of cursor location when used or not cursor sensitive, a notification setting indicating a desire to be informed of the cursor location or not, a time the application is in focus, an amount of time since an application has been in focus, and a time limit for an amount of time an application may be out of focus. For example, if an application type indicates cursor sensitive then a notification setting will be set to yes. Similarly, if a user wishes to be notified, the notification setting will be set to yes. The notification setting thus determines if a notification should be provided in the event certain conditions are met.

The comparator in a first case compares the location of the cursor obtained by the location tracker of monitor 502 with the viewable display information from the tracking of the viewable display of monitor 502 to determine if the cursor is viewable. If the cursor is not viewable and the user has elected to be notified, having a notification setting of yes, analysis 504 will then call the services of cue 506.

Analysis 504 is also capable of analyzing the focus status of the applications. For example, analysis 504 using a comparator in a second case will determine whether the application in focus has been out of focus for some duration of time longer than the time limit specified by consulting the data parameters maintained in configuration data 508. If the comparison in the second case is true, the comparison in the first case is called to determine if the cursor is off the screen, and if so, sets the notification setting value to yes, which may override a previously set configuration data value, causing a cue to be displayed.

The cue display function provided by the cue 506 component of cursor locator service 312 of FIG. 3 provides a cue to the user indicating the location of the cursor. The cue is typically in the form of a visual cue. The location of the cursor is determined by the location tracker function in combination with tracking the viewable display of monitor 502 to provide a visual cue, such as, a flashing arrow at the appropriate display extremity. Other symbols may be used to indicate the approximate location of the located cursor.

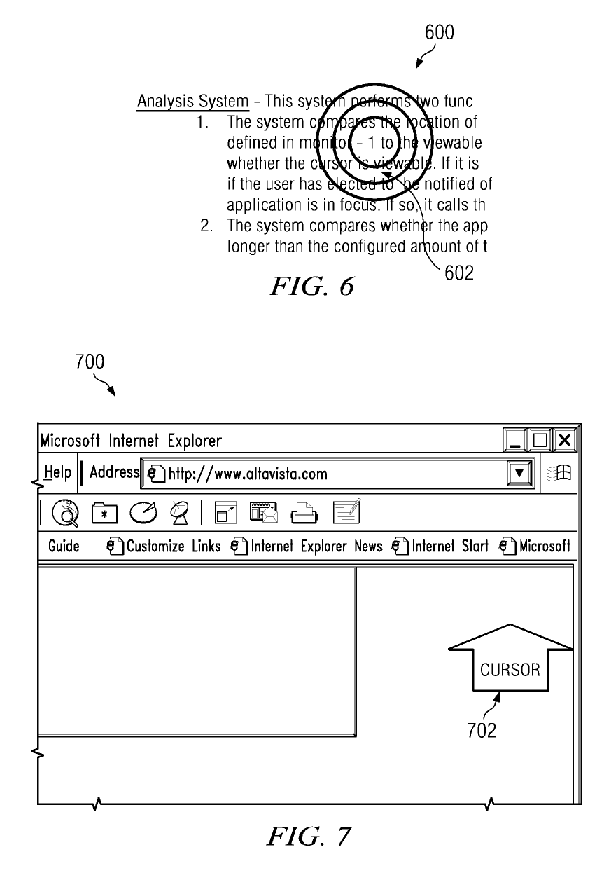

With reference to FIG. 6, an example of a visual cue in an application in focus, in accordance with illustrative embodiments is shown. In this example, an illustrative embodiment thus monitors the location of the cursor within the context of an application window 600, a portion of which is shown, detecting when the application regains focus after a period of time. This may be the case when a user returns to the section being viewed and the cursor is visible, but the user receives a visual indication of where the cursor is visible as a further aid. A visual cue, indicating the cursor location, such as graphic 602, may be displayed to the user at that time.

With reference to FIG. 7, an example of a visual cue in an application when a cursor is off screen, in accordance with illustrative embodiments is shown. Monitoring methods maintain awareness of the application focus state, indicating whether an application is currently being viewed and processed by the user, such as in a portion of the application window 700 or if it is in the background. Upon resumption of application focus, when the cursor is not on screen for that application, a visual cue may be displayed such as graphic 702.

The visual cue may also support providing the user with a selection of actions or help regarding the cursor location. The user may be provided a choice of jumping directly to the cursor location, scrolling to the location, receiving an indication of how far, for example, the number of pages or screens the cursor is located from the present location, and receiving a hint for added help. The prompt choices may be contained on the cue itself or as an additional message on screen, responsive to the presence of the cue. The selection of a particular graphic may be controlled via user preference settings related to the viewer or application being used. Other configurable choice implementations could be used as well, such as an application property file, configuration file or add-on.

The user may be determined to be “lost.” A determination may be made based on certain events or actions of the user, comprising, “no action after returning focus to an application,” “maneuvering the pointer in a random, non-useful manner (that is, moving the pointer, but not actually clicking anything, or not moving the pointer in a relatively straight line)”, “a user declaration via clicking a button, giving a voice command, that they are lost”, or “a user pressing arrow keys back and forth.”

Additionally, a visual cue indicating the location of the cursor on the screen may be displayed when specific types of applications such as those that are cursor sensitive, for example, text-centric applications, return to focus.

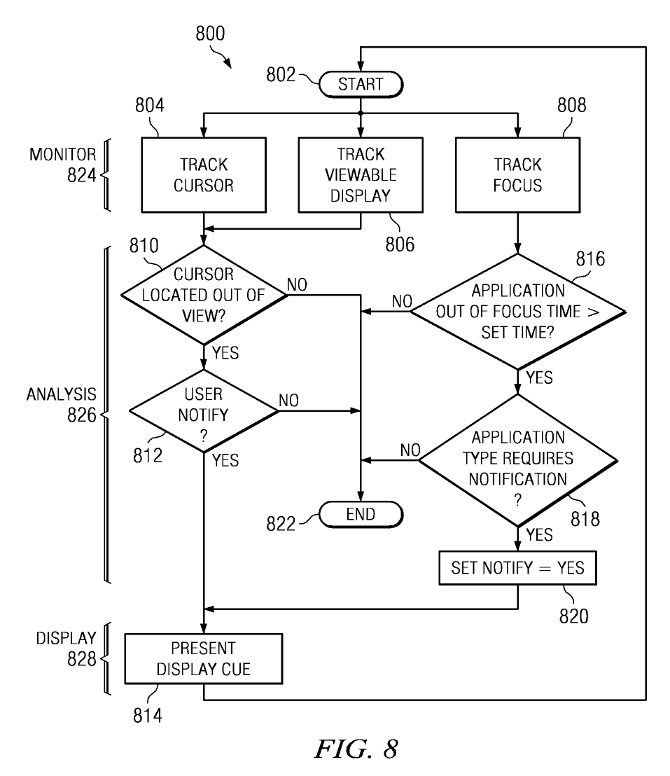

With reference to FIG. 8, a flowchart of the cursor location service process in accordance with illustrative embodiments is shown. Process 800, of cursor location service 312 of FIG. 3, begins at start (step 802) proceeding to initiate parallel functions of tracking as in the steps of track cursor 804; track viewable display 806 and track focus 808.

Track cursor tracks the location of the cursor within an application (step 804). Track viewable display provides periodic indication of the window size and of the elements of the application that are viewable within the window (step 806). Track focus determines, for an application that is in focus, the time an application window has been in focus and the time since it has been in focus and stores that information for later comparison operations (step 808).

An analysis is performed on the in focus application to determine if the cursor is currently outside of the viewable display area (step 810). If the cursor is not located out of view, step 810 determines a “no” otherwise a “yes” is determined. If a “no” is determined, process 800 ends (step 822). If a “yes” was determined, then process 800 determines if the user desired to receive notification (step 812).

Having determined a “yes” in step 812, a visual cue is presented to the user (step 814) and return to repeat step 702 to start again.

Returning now to focus tracking of step 808, process 800 determines if an application's out of focus time is greater than a predetermined time specified in the configuration data (step 816). If the out of focus time of the tracked application is not greater than a predetermined time, a “no” is determined and the process terminates thereafter (step 822). Otherwise, a “yes” is determined and process 800 moves to determine if the application is of a type that requires notification (step 818).

If the application does not require a notification, a “no” is determined for step 818 and the process 800 terminates thereafter (step 822). If the application requires notification a “yes” is determined in step 818 and a setting of “notify=yes” is made for this use of the notification setting of the respective application, possibly overriding a user provided value or other setting in the configuration data (step 820).

Having updated the notification setting, process 800 displays a visual cue (step 814) and returns to start (step 802) again. Visual cues may be selectable and may provide a simple indication of direction in which to search for the missing cursor. Additional information may be supplied by a cue to aid the user in reaching the missing cursor in a parked location. For example, to provide information for a cursor that has been parked several screens before, a cue image in the form of an upward pointing arrowhead may provide help in the form of a rollover text, prompting a user to select an action, such as, selecting the cue image to jump to the specific location of the parked cursor or scroll in the direction indicated by the cue to gradually return.

FIG. 8 also provides a correspondence of the components of FIG. 5 with the operations of process 800. Portions of process 800 comprising monitor 824, analysis 826 and display 828 correspond to components of cursor location service 312 as shown as monitor 502, analysis 504 and cue 506 of FIG. 5, respectively.

Thus, the illustrative embodiments provide a capability to collect a set of values regarding the location of the cursor within the graphical user interface space of an application and compare the set of collected values with a set of respective predetermined values. Responsive to a determination based on the set of compared values, a visual cue is presented indicating the location of the cursor to the user.

For example, in a spreadsheet application a user may have scrolled through pages of data, leaving the cursor location many pages behind the current view on the display. In accordance with embodiments of the present invention the actual location of the cursor would be tracked and due to the requirements of the application to be cursor sensitive update the user. The user would then receive a visual cue, on the current display, indicating the location of the cursor allowing the user to quickly return to the cursor location or realize where the cursor is located.

Illustrative embodiments typically provide increased efficiency through non-disruptive notification to the user when the cursor is in a potentially unexpected location, and enables the user to be effective when returning to an application window. A convenience factor to users, who either do not know how to identify cursor location or who would prefer not to have to manually identify where the cursor is within an application, is also provided.

Illustrative embodiments of the present invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable type medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for indicating the location of a cursor within an application, the computer implemented method comprising:
monitoring the application to generate a set of collected values regarding the location of the cursor;
comparing the set of collected values with a set of respective predetermined values to create a set of compared values; and
presenting a visual cue indicating the location of the cursor on a display, responsive to a determination based on the set of compared values.

2. The computer implemented method of claim 1 wherein the monitoring the application further comprises:
a tracker capable of creating the set of collected values indicating a location of the cursor within the application, and a viewable display, and also a time the application is in focus.

3. The computer implemented method of claim 1 wherein comparing the set of collected values further comprises:
comparing the location of the cursor to a corresponding one of the set of respective predetermined values;
comparing a notification setting to a corresponding one of the set of respective predetermined values;
comparing an application out of focus time to a corresponding one of the set of respective predetermined values;
comparing an application type to a corresponding one of the set of respective predetermined values, wherein the set of respective predetermined values is obtained from a corresponding set of configuration data.

4. The computer implemented method of claim 1 wherein presenting a visual cue further comprises:
providing the visual cue comprising prompting for a user input selecting an action, including obtaining help, regarding the cursor location.

5. The computer implemented method of claim 1 wherein the determination based on the set of compared values further comprises:
responsive to determining that a user is lost, jumping to the cursor location; and
responsive to jumping to the cursor location, providing a visual cue at the cursor location.

6. The computer implemented method of claim 1 wherein the application is cursor sensitive application.

7. The computer implemented method of claim 1 wherein presenting a visual cue further includes a visual cue including a capability for selectively jumping, directly, to the cursor location.

8. A data processing system for indicating the location of a cursor within an application, the data processing system comprising:
a bus;
a memory connected to the bus, wherein the memory contains computer usable program code;
a persistent storage;
a display;
a communications unit; and
a processor unit connected to the bus and the memory, where in the processor unit executes the computer usable program code to:
create a monitor capable of generating a set of collected values regarding the location of the cursor;
create a comparator capable of comparing the set of collected values with a set of respective predetermined values to create a set of compared values; and
create a cue function capable of presenting a visual cue indicating the location of the cursor on the display, responsive to a determination based on the set of compared values.

9. The data processing system of claim 8 wherein the monitor capable of generating a set of collected values further comprises:
a tracker capable of creating the set of collected values indicating a location of the cursor within the application, and within a viewable display, and also a time the application is in focus.

10. The data processing system of claim 8 wherein the comparator capable of comparing the set of collected values further comprises:
a comparator capable of comparing the location of the cursor to a corresponding one of the set of respective predetermined values;
a comparator capable of comparing a notification setting to a corresponding one of the set of respective predetermined values;
a comparator capable of comparing an application out of focus time to a corresponding one of the set of respective predetermined values;
a comparator capable of comparing an application type to a corresponding one of the set of respective predetermined values, wherein the set of respective predetermined values is obtained from a corresponding set of configuration data.

11. The data processing system of claim 8 wherein the cue function further comprises:
a capability of providing the visual cue comprising prompting for a user input selecting an action, including obtaining help, regarding the cursor location.

12. The data processing system of claim 8 wherein the cue function further comprises:
a capability of, responsive to determining that a user is lost, jumping to the cursor location; and
responsive to jumping to the cursor location, providing a visual cue at the cursor location.

13. The data processing system of claim 8 wherein the application is of a cursor sensitive type.

14. The data processing system of claim 8 wherein the cue function capable of presenting a visual cue further comprises:
the visual cue including a capability for selectively jumping, directly, to the cursor location.

15. A computer program product for indicating the location of a cursor within an application, the computer program product comprising computer usable program code tangibly embodied on a computer usable recordable type medium, the computer usable program code comprising:
computer usable program code for creating a monitor capable of monitoring the application to generate a set of collected values regarding the location of the cursor;
computer usable program code for creating a comparator capable of comparing the set of collected values with a set of respective predetermined values to create a set of compared values; and
computer usable program code for creating a cue function capable of presenting a visual cue indicating the location of the cursor on a display, responsive to a determination based on the set of compared values.

16. The computer program product of claim 15 wherein the computer usable program code for creating a monitor further comprises:
computer usable program code for a tracker capable of creating the set of collected values indicating a location of the cursor within the application, and within a viewable display, and also a time the application is in focus.

17. The computer program product of claim 15 wherein computer usable program code for comparing the set of collected values further comprises:
computer usable program code for comparing the location of the cursor to a corresponding one of the set of respective predetermined values;
computer usable program code for comparing a notification setting to a corresponding one of the set of respective predetermined values;
computer usable program code for comparing an application out of focus time to a corresponding one of the set of respective predetermined values;
computer usable program code for comparing an application type to a corresponding one of the set of respective predetermined values; and wherein the set of respective predetermined values is obtained from a corresponding set of predetermined configuration data.

18. The computer program product of claim 15 wherein the computer usable program code for presenting a visual cue further comprises:
computer usable program code for prompting for a user input selecting an action, including obtaining help, regarding the cursor location.

19. The computer program product of claim 15 wherein computer usable program code for the determination based on the set of compared values further comprises:
computer usable program code responsive to determining that a user is lost, for jumping to the cursor location; and
responsive to jumping to the cursor location, providing a visual cue at the cursor location.

20. The computer program product of claim 15 wherein computer usable program code for creating a cue function capable of presenting a visual cue further comprises:
computer usable program code for a visual cue including a capability for selectively jumping, directly, to the cursor location.
